(19) United States
(12) Patent Application Publication
(10) Pub. No.: US 2016/0314536 A1
(43) Pub. Date: Oct. 27, 2016

(54) Systems and Methods for Determining and Recovering Salvage Value of Property and Building Materials

(71) Applicants: Christopher Bates, Batavia, IL (US); Karl Stanton, St. Charles, IL (US)

(72) Inventors: Christopher Bates, Batavia, IL (US); Karl Stanton, St. Charles, IL (US)

(21) Appl. No.: 14/694,652

(22) Filed: Apr. 23, 2015

(51) Int. Cl. G06Q 40/08; G06Q 10/00

(52) U.S. Cl. CPC G06Q 40/08; G06Q 10/30

(57) ABSTRACT

The present disclosure relates to a systems and methods for determining, handling, tracking, and recovering salvage value. Specifically, the present disclosure relates to systems and methods for determining the value of insured-retained salvage, as well as, determining a salvage value for property turned over to an insurance company. The present disclosure also relates to systems and methods for determining the value of building material salvage, specifically building materials as a recyclable commodity, thereby offering environmentally-friendly solutions. The present disclosure further relates to systems and methods for handling content recovery management, specifically for content related to an insurance loss, thereby offering solutions for the same that are environmentally-friendly and/or charitable.

### TECHNICAL FIELD

The present disclosure relates to a salvage recovery program. Specifically, the present disclosure relates to systems and methods for documenting, tracking, valuating and recovering salvageable property, which includes various modules accessible by at least one access device over a data communication network. The present disclosure also relates to systems and methods for determining the value of building material salvage, specifically salvaged building materials as a recyclable commodity, thereby offering environmentally-friendly solutions. The present disclosure further relates to systems and methods for handling content recovery management, specifically for content related to an insurance loss, thereby offering solutions for the same that are environmentally-friendly and/or charitable.

### BACKGROUND

Natural and other disasters happen every day destroying or damaging property and personal belongings. To mitigate property losses from natural and other disasters, home and business owners carry insurance to cover potential losses to both real and personal property. In many situations, there is property that is only partially damaged. Although the property is replaced by the insurance company, some partially damaged property continues to retain value. Currently, the insurance provider has no system for documenting, tracking and recovering the value on these items. As such, the property owner or vendor mitigating the loss benefit from the value that rightly belongs to the insurance provider. In those situations, the property owner or vendor may decide to retain the item for free or at much lesser value.

When personal property is damaged, a claim is submitted to an insurance company. Depending on the type of policy, the insurance company will either pay the actual cash value (ACV) or replacement cost value (RCV) for items deemed a total loss. In general, the policyholder is paid the ACV amount on the front end and then the difference between the ACV and RCV (commonly known as depreciation) once a replacement item has been purchased. Once the policyholder has been fairly compensated for the contents under the terms of their specific policy, the item(s) now technically belong to the insurance company. The insurance company then determines what to do with the item(s). More often than not, the property is disposed of or retained by the policyholder or vendor regardless of its value. In the insurance industry, “salvage value” is the amount for which an asset can be sold in its current condition. In property insurance, salvage value will be subtracted from any loss settlement if the insured retains the damaged property. However, the insurance industry currently has no system to determine this value and therefore recover little, if any, actual value from these items. In the rare occurrence that this happens today, the value of salvage is considered by an insurer as a “credit” against what they owe the insured for an insured loss, based upon the terms and conditions of the policy.

Damaged property owned by the insurance company is either disposed, retained by the policyholder or vendor, or turned over to a professional salvage dealer. The salvage dealer is generally paid a commission to handle and then sell the property. However, this process rarely occurs today and there is no system in place to track when it does.

In a second option, the insured decides to keep the damaged property. In this instance, the insurance company places a salvage value on the property, and then pays the owner the difference between the policy and the determined salvage value. The owner then determines how he/she wishes to handle the retained property. Currently, the insurance industry does not have a viable option for determining these values and therefore either gives it away or places a much lower than market value on the items. In either event, there is no system to track when this happens.

Every insurance carrier can find a file where a vendor has been paid to clean and restore an item that did not restore to pre-loss condition. The item was placed on a total loss inventory, and the policy holder was compensated. Often salvage value is not recovered for the item, and many times it is not even considered. Thus, the money wasted on uncaptured salvage value is significant.

In addition to losses of personal property, oftentimes during a natural disaster such as a tornado, there is often considerable damage to the outside of the property. For example, siding, copper roofing, gutters and trim may be torn off or damaged. All of these building materials may become valuable recyclable salvage, depending on the determination of the insurance company. More often than not, salvageable building materials are undervalued and/or discarded. In general, the insurance company does not receive any value from the building materials because they have no way of determining its actual value or the savings they could recover by not throwing it away. That said, there are rare occasions where insurance professionals will remove a disposal amount from a settlement if they know the vendor will be recycling the building mater.

The problem that arises is determining, tracking and recovering a fair value for salvage of the damaged property. Insurance companies simply do not have the time, manpower or resources to determine or follow-up on the potential value of the salvaged property. Additionally, because they do not have the time, manpower or resources to handle salvaged property, insurance companies will allow the vendor to recycle the materials and retain the value themselves, without determining the potential value of the recyclable material. This process results in financial losses to the insurance company because the materials being replaced belong to the insurance company.

Conventional techniques involve using a salvage expert to determine salvage values. However, it is costly and time-consuming for an insurance company to repeatedly pay for the services of an expert. Often, the professional salvage dealer will determine the “net value” of the property after handling and moving expenses are considered. A number of factors can be involved in determining the value of salvage, including location, market value, handling, and even the expertise of the person selling the property. Thus, opinions of experts may vary widely, and not necessarily reflect actual salvage values.

In sum, conventional techniques for estimating salvage values of items, be they personal items from a homeowner or potentially recyclable building materials, typically estimate the values below fair market value, increase the costs for insurance companies or result in little to no return, and/or may fail to produce a record of how salvage values are determined.

Thus a need exists for a system and method for determining, handling, tracking and recovering the value of salvage. Specifically, a need exists for determining, handling, tracking and recovering the value of salvage property, providing monetary value to the insurance industry.

Additionally, a need exists for a system and method for determining, handling, tracking and recovering the value of salvage that does not demand time or follow-up from claims adjusters.

Additionally, a need exists for determining, tracking and recovering the salvage value of higher-priced items, including determining a fair market value of a salvageable item.

Further, a need exists for quickly determining, tracking and recovering the salvage value of a lower-priced item, providing an instant quote to the user.

Moreover, a need exists for determining, tracking and recovering the value of building material salvage, including capturing the value of building materials as a recyclable commodity.

Further, a need exists for assisting the insurance industry in recovering salvage dollars on residential and business insurance claims.

Additionally, a need exists for providing an environmentally-friendly solution by transforming damaged building materials from a disposal item to a recyclable item that provides return to insurance companies.

Moreover, a need exists for determining, handling, tracking and recovering the value of contents related to an insurance loss.

In addition, a need exists for determining, handling, tracking and recovering contents by classifying according to its disposition, and valuing the contents based on its classification.

### SUMMARY OF THE INVENTION

The present disclosure relates to a systems and methods for determining, handling, tracking and recovering salvage value. Specifically, the present disclosure relates to systems and methods for determining, tracking and recovering the value of insured-retained salvage, as well as, determining, handling, tracking and recovering a salvage value for property turned over to an insurance company. The present disclosure also relates to systems and methods for determining, tracking and recovering the value of building material salvage, specifically building materials as a recyclable commodity. Additionally, the present disclosure relates to systems and methods for developing a contents recovery management program for determining, handling, tracking and recovering contents during a property loss.

To this end, in an embodiment of the present disclosure, a method for determining, handling, tracking and recovering the salvage value of an item is provided. The method comprising the steps of: providing a server in communication with one or more access devices over a data communication network, the server programmed to receive data to itemize personal property of a property owner; provide access to the data by an insurance adjuster; providing a valuation module on the server in communication with the one or more access devices through the data communication network to receive the data relating to a property loss of one or more personal property items; and, calculating the salvage value of the item using the valuation module, wherein the item is transformed from a disposable item into a salvageable item.

In another embodiment of the present disclosure, a salvage valuation system is provided. The valuation system comprises a valuation module configured to communicate with one or more computing devices over a data communication network, wherein the module is accessible to insurance adjusters and salvage agents, the valuation module further comprising a pricing module configured to receive data over the data communication network and using the data to calculate a value of an item submitted as property loss; and, a salvage module configured to receive data over the data communication network and using the data to calculate the value of an item submitted as a property loss to an insurance company, wherein the item is transformed through the pricing module from a disposable item into a salvageable item.

In yet another embodiment of the present disclosure, a system and method for determining the salvage value of building materials is provided. The method comprises the steps of providing a server in communication with one or more access devices over a communication network, the server programmed to receive data to itemize building materials submitted as a loss; accessing the data by a salvage agent and an insurance adjuster; providing a building materials module on the server in communication with the one or more access devices through the network to receive the data relating to a loss of building materials; and, calculating a recycle value and disposal savings of the building materials using the building materials module; transforming the building materials from a disposable item into a recyclable or reusable item; and crediting the insurance company based on the recycle value and the disposal savings.

In another embodiment of the present disclosure, a building materials valuation system is provided. The system comprises a building materials valuation module configured to communicate with one or more computing devices over a data communication network, wherein the module is accessible to insurance adjusters and salvage agents, wherein the building materials module is configured to receive data over the data communication network and using the data to calculate a value of building materials submitted as property loss; and, wherein the building materials are transformed through the building materials valuation module from a disposable item into a salvageable item.

It is, therefore, an advantage and objective of the present disclosure to provide a system and method for determining, handling, tracking and recovering the value of salvaged property recovered from a homeowner or business after placing a loss claim with an insurance company.

It is also an advantage and objective of the present disclosure to provide a system and method for determining, tracking and recovering the salvage value of an item claimed as a property loss.

It is further an advantage and objective of the present disclosure to provide a system and method for determining, tracking and recovering the salvage value of an item claimed as a property loss and turned over to an insurance company.

Moreover, it is an advantage and objective of the present disclosure to provide a system and method for determining, tracking and recovering the salvage value of building materials as a recyclable commodity.

Additionally, it is an advantage and objective of the present disclosure to enable insurance companies to make educated decisions concerning the salvage value of various for providing additional revenue and potentially passing along the savings to policyholders.

It is further an advantage and objective of the present disclosure to provide an environmentally-friendly solution by transforming damaged building material from a disposal item to a recyclable item.

Moreover, it is a further advantage and objective of the present disclosure to provide a system and method for determining, handling, tracking and recovering the value of contents related to an insurance loss.

It is an additional advantage and objective of the present invention to provide a system and method for determining, handling, tracking and recovering contents by classifying according to its disposition, and valuing the contents based on its classification.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram illustrating an exemplary embodiment of a system for determining, handling, tracking and recovering property salvage value including building materials as a recyclable commodity and contents recovery management;

FIG. 2 is a block diagram illustrating an exemplary embodiment of a module for determining, handling, tracking and recovering salvage value for an item claimed as a property loss and turned over to an insurance company;

FIG. 3 is a block diagram illustrating an exemplary embodiment of a module for determining, tracking and recovering salvage value for owner-retained property after a loss;

FIG. 4 is a block diagram illustrating an exemplary embodiment of a module for determining, tracking and recovering the salvage value for building materials as a recyclable commodity; and,

FIG. 5 is a block diagram illustrating an exemplary embodiment of a module for determining, handling, tracking and recovering the potential salvage and recoverable value of an entire content loss.

### DETAILED DESCRIPTION

The present invention relates to systems and methods for determining, handling, tracking and recovering the salvage value of personal property. The salvage items may be items from a home, business or another form of property, which are submitted through an insurance claim after a loss, such as from a natural disaster. The present systems and methods are used to determine the value of the salvaged item or items, including when the item is retained by the owner, or alternatively, turned over to the insurance company for further handling.

Additionally, the present systems and methods are useful for determining, handling, tracking and recovering the salvage value of building materials. Many times after a natural or other disaster, valuable building materials are often recycled by someone other than the owner (i.e., the insurance company). The present system and method is useful for determining whether the building materials hold value as recyclable materials as well as provide a reduction in disposal costs, providing revenue streams not previously considered by insurance companies.

These systems and methods can assist both property owners and insurance companies in making educated decisions concerning the value of homeowner personal property items submitted as losses through insurance claims, as well as, determining the value of building materials as a recoverable, recyclable items. The present systems and methods are useful for determining the salvage and potential recyclability of personal items and building materials when there is a total content loss.

In embodiments of the present system, system 10 and its associated salvage recovery module 100 and owner-retained pricing module 200, and building materials module 300, and contents recovery management module 400 are implemented in one or more computers. The system 10 and associated modules may include any computer hardware and/or software instructions or combinations of the same configured to perform the presently described processes. It should be understood that the present systems and processes may be implemented on one or more physical computing devices, and that the present systems may include any number of computing devices, including servers, databases and other like hardware and associated software and may employ any number of operating systems known in the art. Further, it should be understood that the present systems, processes and methods are useful for converting a previously useless and often disposed of item into a salvageable item.

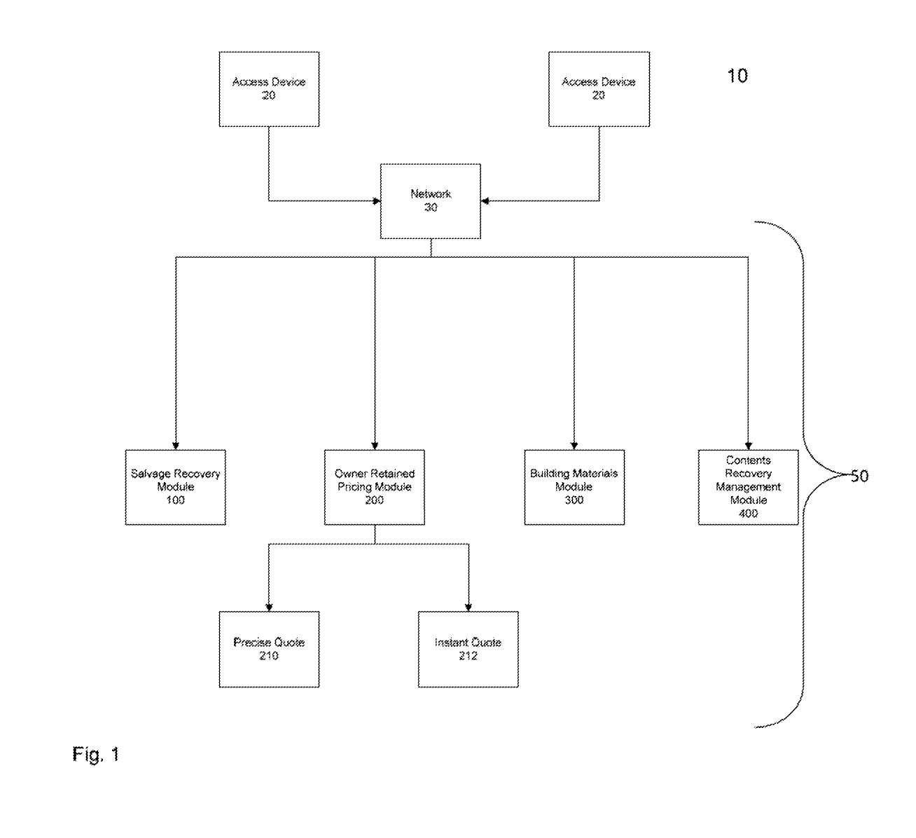

Now referring to the figures, wherein like numerals refer to like parts, FIGS. 1-5 illustrate an example of a system and methods for determining, handling, tracking and recovering salvage value, and more specifically, a system and modules for determining, handling, tracking and recovering salvage value of personal property and business owned property. The systems and methods can be used to determine, handle, track and recover the salvage value of property being submitted through an insurance claim, which is either retained by the insured, or when the property is relinquished to the insurance company. By entering data into a valuation module, which is accessible from an access device over a data communication network (Internet), the salvage value of an item either retained by the property owner or turned over to the insurance company as a loss claim, can be determined.

If the item is retained by the property owner, the insurance adjuster using the present system and modules can determine the residual value of the item and adjust the payment to the property owner based on the calculated value. Alternatively, if the item is relinquished to the insurance company, the present systems and modules can be used to handle, track and recover the value of the item, including whether the item requires restoration or refurbishing, prior to an eventual sale. Accordingly, the present system and methods are used to recapture the money previously lost on uncaptured salvage value.

As shown in FIG. 1, a system 10 is shown for calculating, handling, tracking and recovering salvage value. In the system 10, a valuation module 50, comprising one or more of the modules 100, 200, 300 and 400 are accessible from least one access device 20, including but not limited to, desktop computers, laptop computers, tablets, and cell phones, through a standard data communication network 30, including but not limited to the Internet. Other communication networks can include intranets, local area networks and any other communication networks capable of carrying communications between access devices 30 and the system 10. It should be understood that the access device 20 may include any device or devices physically or remotely accessible to one or more users and that allows a user to provide input to and/or receive output from the present modules. Further, the system 10 may be configured to recognize different classes of users and to provide different levels of access to the different user classes. For example, the system 10 may be accessible to insurance company adjusters/agents, salvage agents and salvage vendors. The system 10 further includes one or more of a salvage valuation module 100, an owner-retained pricing module 200, a building materials module 300 and a contents recovery management module 400.

Salvage Recovery Module and Process

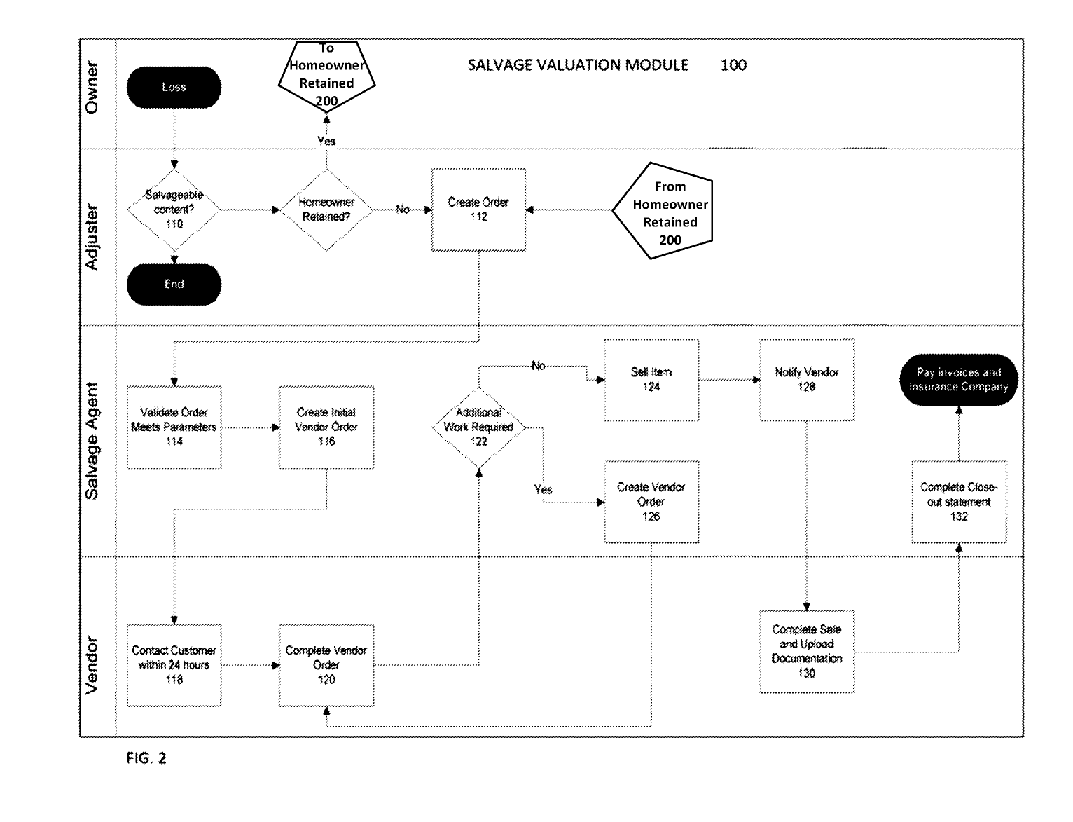

Referring to FIG. 2, the system 10 includes a salvage recovery module 100. The salvage recovery module 100 is used in the process of determining, handling, tracking and recovering value when an insurance adjuster identifies salvageable content after a loss claim is submitted by a property owner or homeowner. As mentioned, the salvage recovery module 100 can be configured to recognize different users and to provide different levels of access and security to the different users. For example, the users typically having access to the salvage recovery module 100 include insurance company adjusters/agents, salvage agents and salvage vendors who access the module through any number of access devices 30.

The present salvage recovery module 100 can be used to determine the salvage value of an item submitted through an insurance claims. As shown in FIG. 2, the process includes an initial submission by the property owner of a loss claim to the insurance company. The insurance adjuster then determines whether there is salvageable content 110 in the claim. Specifically, salvageable content is generally identified using a set of criteria, which may include, but is not limited to: a set replacement value, without depreciation; a set percentage of the item having visible damage beyond surface soiling; the estimated cost to restore is less than 20% of the replacement value; restoration can restore full usefulness of the item; other personal property contacts on the loss are being salvaged; and the item has a value to the potential buying market of at least a set dollar amount. The items meeting the criteria are entered into the salvage recovery module 100, and if there is salvageable content, the process continues. If the property/homeowner decides to retain the loss property, the system shifts to the owner retained pricing module 200, which will be discussed below.

If the property owner does not retain the property, an order 112 is created, which is then transferred to the salvage agent. The salvage agent reviews the order to determine if it meets the salvageable criteria 114 discussed above, and if so, the salvage agent creates an initial salvage vendor order 116.

Salvage vendors are generally recovery specialists who are given the task of recovering the items from the property owner. Once the order 116 is created and transferred to the salvage vendor, the salvage vendor contacts the property owner 118 to pick up the salvage items. The salvage vendor picks up the items, uploads photographs and information into the salvage recovery module 100 and the order is complete 120.

Once the order is complete, the salvage agent and salvage vendor review the item or items to determine whether additional work 122 is required on the items before re-selling the items. For example, the salvage operator will determine if the item needs ozone/deodorizing, cleaning, refinishing, new hardware, tuning (pianos) or any other form of specialty cleaning, for example, for electronics. If additional repair/reconditioning is required, the salvage operator creates an order 126 for the salvage vendor who performs the work. When the item is repaired/recondition, the new order is completed and uploaded, and it is ready for sale.

Alternatively, if an item does not require refurbishing, the item may go directly to sales 124. Sales of items can take place through many channels, including but not limited to, Afford 2 Furnish, Craig's List, EBay, Bookoo Yard sale, Facebook or even local classified advertisements. The salvage agent conducts the sale of the items, which may be housed at the vendor location. After selling an item, the salvage vendor is notified 128, the sale is completed and uploaded 130 into the module, and a closeout statement is generated 132. Any outstanding invoices, taxes, etc. are documented and paid from the proceeds of the sale.

The present salvage recovery module 100 allows for tracking and creating reports relating to the value of the salvaged item, which previously, without this valuation system, would have typically been discarded as a loss. The insurance company and/or adjuster has complete access to the status, pictures, and other documentation relating to all salvaged orders any and all times through the module 100. Further, the insurance adjuster has the ability to contact the salvage agent through known communication means, including email, to consult on the status of a salvage project. Additionally, the insurance adjuster has the ability to see the “payment statements” for each item sold through the system. The statements include information relating to sale price, taxes, expenses, fees, retained commission and the amount payable to the insurance company. Furthermore, reports can be created for management level personnel, for example, relating to documenting company totals and adjuster lever activity.

Owner-Retained Pricing Module and Process

In many instances, property owners decide to retain a damaged item. Essentially, an insurance adjuster allows the property owner to keep the item, for which the insurance company pays an Actual Cash Value (“ACV”) or Replacement Cost Value (“RCV”) price for the claim. In some circumstances, the item is “sold” back to the property owner for a minimal amount, i.e., $25 or less because there has been no method to determine the market value of these items. A minimal amount for an item may be set, because the insurance company does not want to put its adjusters in the position of being a “salesperson” with the property owner; however, the proposed minimal amount may not reflect the actual value of the item. Additionally, property owners know that an adjuster is not in a position to do anything else with the items. It is often time-consuming and cost-prohibitive for an insurance adjuster to research a salvaged item to determine a “fair” price for sale back to the property owner. Because items are often undervalued, the insurance company gains little or no monetary benefit from the owner-retained item.

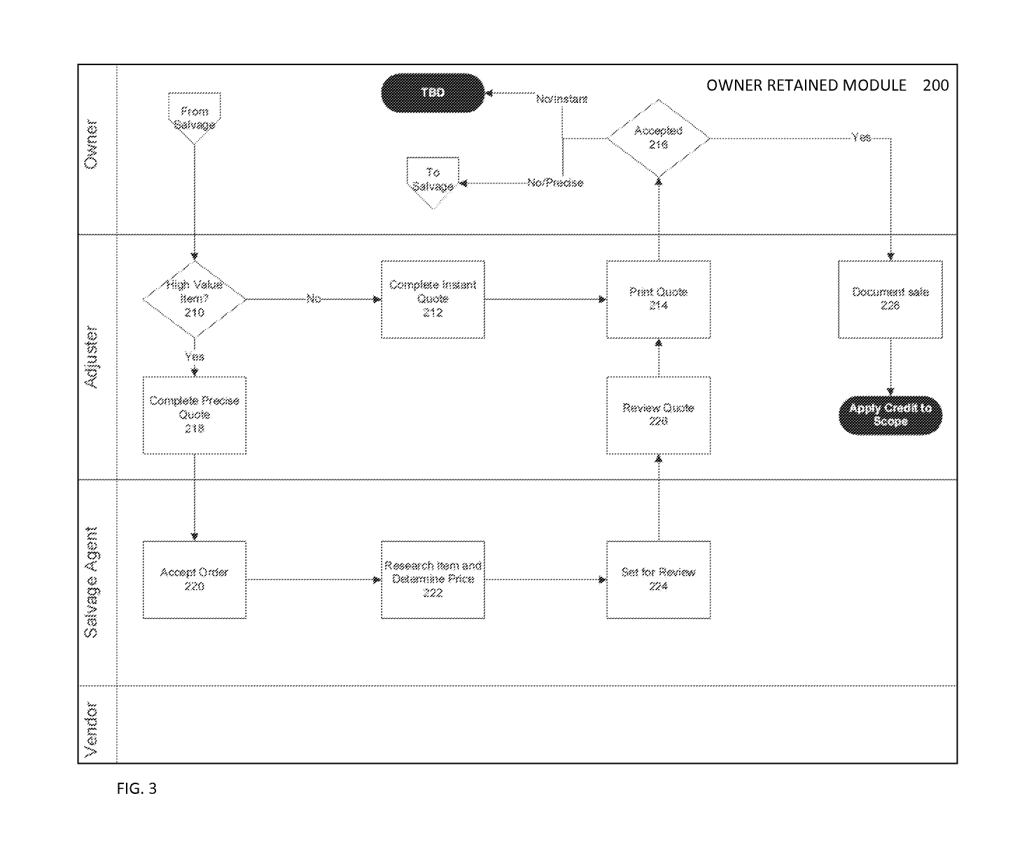

Referring to FIG. 3, there is shown an owner-retained pricing module 200. The owner-retained pricing module 200 includes two pricing tools—a precise quote 210 and an instant quote 212. The precise quote 210 is meant for determining the value of higher priced items that are worth taking the time to research as to value. A precise quote 210 requires considerable data from the insurance adjuster concerning the item, as well as, research by the salvage agent to determine a value that the salvage agent believes the item could sell for on the market. Under the precise quote module 210, the estimated value is returned to the adjuster within 24 hours in the form of a printable report.

The instant quote 212 is meant for lower value items and provides a quote within seconds of entering the date into the module. The instant quote 212 includes a database of information relating to thousands of standard household items, from which an adjuster can select to determine the instant quote value of an item. Both the precise quote 210 and the instant quote 212 provide to a third party the value of an item so the adjuster is not in the position of determining the value that may be retained by the property or homeowner. Overall, the owner retained pricing module 200 assists the insurance adjuster in determining a fair price to “sell” the item back to the property owner. Specifically, the “selling” does not include any money exchanging hands, but rather a deduction off the value of the total loss inventory payment to the property owner.

The process of value determination under the owner retained pricing module 200 includes the following steps: Information relating to a salvage item is entered into the module. The insurance adjuster determines whether the item is a high value item (precise quote) 210, such as a baby grand piano, or lower value item (instant quote) 212, such as a dishwasher.

In the instant quote 212, a drop down menu provides multiple categories of information relating to the over 1000 household items. The information can include such parameters as category of item, i.e., appliances, furniture, etc., type of item and description of the item. These three parameters are used to fine the item easier and are also useful to determine the appropriate depreciation table to be applied to the item. Additional parameters used in calculating the instant quote include: grade, which is used to determine a replacement cost value of an item having a similar quality; condition, which is used to assess the amount of damage to the item; and age, which is used to determine appropriate depreciation. Once the appropriate parameters are entered into the module 200, the instant quote 212 is calculated, providing a value range. The instant quote is reviewable by and can be printed 214 by the insurance adjuster.

After review by the adjuster, the instant quote may be forwarded to the property owner. If the property owner accepts 216 the quote, the insurance adjuster then applies a credit for the agreed upon amount to the final settlement. Additionally, the “sale” is recorded 228 by the adjuster into the module. Alternatively, if the item is not sold, the quote is discarded in the system, and a determination needs to be made by the adjuster as to how to handle the property. If it meets salvage criteria as defined above, the item may be entered into the salvage recovery module 100. If not, the adjuster decides how to dispose of the property.

If the item is a higher quality item, the module 200 provides the adjuster with a process to determine a precise quote 210. For the precise quote 210, the adjuster provides as much information as possible from drop down menus and text fields relating to the overall condition, age, etc., of the item, as well as, submitting photos of the item. Additional information useful for calculating the precise quote 210 include, but are not limited to: providing manufacturer information and serial numbers for items; accurately describing actual damage and overall condition of the item; providing photo-documentation of the item; providing original purchase price; and providing age of the item. All of these variables are useful in calculating a more accurate quote on the item.

Once the information relating to the item is entered, the adjuster clicks complete precise quote 218, and the module creates an order 220 for the salvage agent. The salvage agent researches 222 the item and creates a price quote report based on its research, which is sent back to the insurance adjuster for review 224. The insurance adjuster reviews 226 the price quote report, and may further validate the report through its own research links, documents, and conversations with industry professions. The price quote report 226 is not an appraisal, but rather the price for which the salvage agent believes the item can be sold for in the marketplace using the tools and research available at the given moment. If the item is sold 228, the insurance adjuster puts the sale amount into the module 200 and the information is used to create a report on the item. Alternatively, if the item is not sold or is discarded, the report is closed and the property can be entered into the salvage recovery module 100.

Both the instant price quote 212 and the precise price quote 210 take the guess work out of valuing an item, whether ultimately retained by the property owner, or turned over to the insurance company. The quotes 210, 212 are not meant to be appraisals but rather provide an estimate of the potential value of an item, so the insurance adjuster/agent can make an educated decision.

Building Materials Salvage Module

In addition to salvage value for personal/homeowner and business property, there are also opportunities for determining salvage value relating to building materials. The salvage of building materials, and specifically the potential value in recycling building materials often presents itself after natural or man-made disasters. More often than not, during periods of severe weather, for example, buildings are damaged, which are structurally beyond repair. However, the building materials from the property, including but not limited to aluminum siding, copper roofing, wiring and piping, asphalt shingles, etc., may have value as recyclable commodities.

Currently, capturing building materials as a recyclable commodity is not an insurance industry standard. In fact, vendors are regularly paid by insurance companies to simply dispose of building materials. Because the vendors have control over the materials, they can choose whether to discard or recycle the materials. Thus, in theory, the vendor is compensated by the insurance company who pays them to take the damaged building materials, and the vendor may further recoup the value for recycling those materials. Generally, insurance companies have no way of determining the value of damaged building materials as potential recyclable materials, or even if they can determine a value, they have no means of recouping the value. Additionally, it is a more environmentally-friendly solution to recycle damaged building materials, whenever possible.

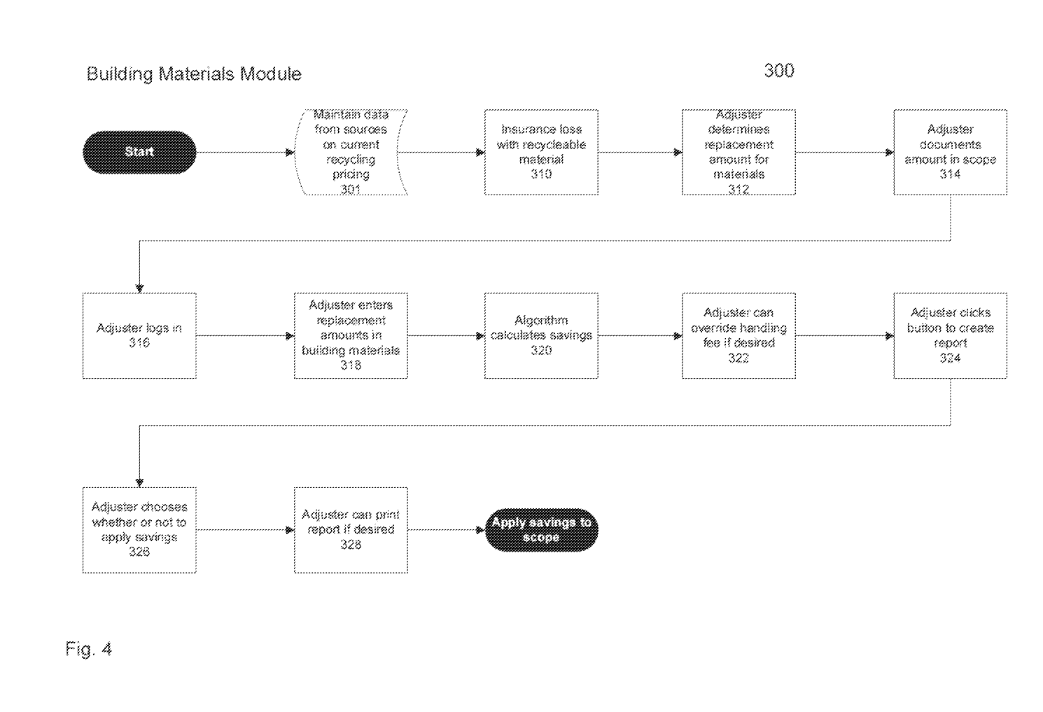

FIG. 4 illustrates a system and process for calculating salvage value of building materials. The building materials module 300 is accessible from least one access device, including but not limited to, desktop computers, laptop computers, tablets, and cell phones, through a standard data communication network, including but not limited to the Internet. The building materials module 300 allows an insurance company to take a credit on the scope of work based on the recyclable material being replaced. Since the insurance company has paid to replace the damaged material, the existing damaged material is owned by the insurance company. The credit for the insurance company is based on at least two components: regional pricing for the amount of the product, and disposal savings based on weight. Additionally, there is a cost to the salvage vendor to process the material for salvage, so a handling fee is provided as an option.

Building Materials Salvage Calculation Module and Process

Referring now to FIG. 4, there is illustrated the building materials module 300 and process for determining the value of recyclable building materials. The module 300 is configured to receive and maintain a database 301 for the current regional recycling price for any number of building materials. These materials may include, but are not limited to, aluminum siding, gutters, downspouts, soffits, roofing vents, ductwork; copper sheeting, tubing, wire, A/C coils and lines; vinyl siding; asphalt shingles; steel; concrete; all types of flooring materials including carpet, wood and tile; and gypsum board.

An initial step in the process is an insurance loss with recyclable material is entered 310. An insurance adjuster determines an initial replacement amount for the materials 312, which is documented in the adjuster's scope of services for the loss 314. Logging into the system 316, the insurance adjusters enters the replacement amounts of building materials 318. The adjuster chooses the type of material, including, but are not limited to, aluminum siding, gutters, downspouts, soffits, roofing vents, ductwork; copper sheeting, tubing, wire, A/C coils and lines; vinyl siding; asphalt shingles; steel; concrete; all types of flooring materials including carpet, wood and tile; and gypsum board. The module 300 will default to measurement of material as square footage, linear footage, etc. depending on the type of material entered. After the measurement is calculated the amount is added to the order. The module then generates a total value 320, wherein disposal savings is based on weight, a handling fee (if added) based on a percentage of total savings, and a recycling value of each material that is determined on current rates. Alternatively, the adjuster can overwrite the handling fee as a percentage and enter a set value instead. These steps are repeated for each type of building material entered into the module 300.

After all of the material is accounted for, a report 324 can be generated by the insurance adjuster. The present module 300 generates a summary page for review that includes the value of each material entered, appropriate disposal savings for the entire order and a field for the vendor handling fees, which can be over-ridden, or subtracted from the total value and disposal savings. The insurance adjuster can then discard or apply the savings 326, and the adjuster can then use the report to take the deducted savings from the estimated cost/scope of services on the particular claim. If the savings are applied, they are recorded in a table for a final report. The adjuster enters the value as a credit item.

Contents Recovery Management

Contents recovery management system and method provides an overall process for handling and valuing a personal property on a loss. In these cases, the present content recovery management system incorporates the modules discussed previously, in determining the value of an entire loss. The system will generate reports relating to the following components: clean, salvage, recycle, donate and dispose. Although “clean” and “dispose” are current components in a total loss program, “salvage,” “recycle” and “donate” are not. In general, most losses today go directly to “dispose” or “clean.” Typically, the “dispose” information is separated from the “clean” information, so it is difficult to determine the overall impact of the contents on the loss. Additionally, the “salvage,” “recycle,” and “donate” components add potential monetary value to items and the insurance industry, while helping to reduce the carbon footprint generated by the losses by providing green solutions (recycling and donations) for the content.

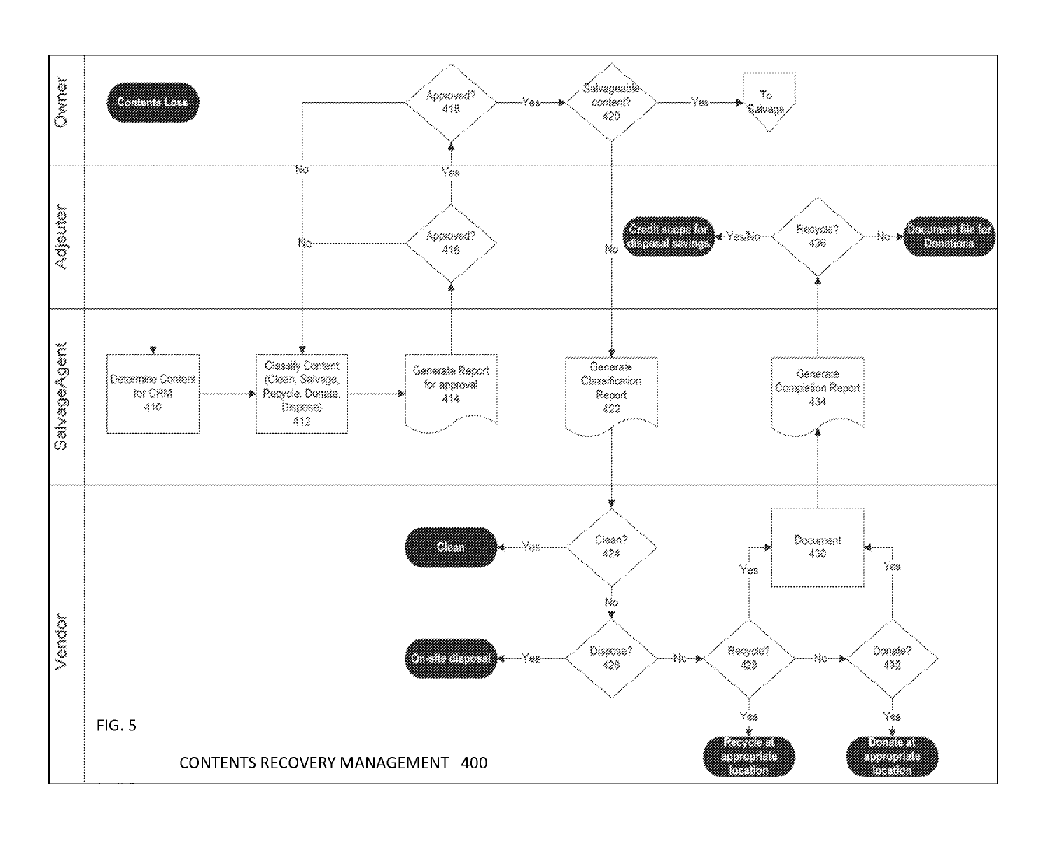

Referring now to FIG. 5, there is illustrated a contents recovery management module 400 and process. The contents recovery management module 400 is configured to receive data relating to a property/homeowner content loss 410. The content loss is submitted to the salvage agent, who classifies the content as one or more of the following categories: “clean,” “salvage,” “recycle,” “dispose,” or “donate” 412. In some instances, it is possible for an item to fall into more than one category. For example, an item may need to be cleaned before it can be recycled or donated. Alternatively, an item may be “clean” and require nothing additional before being sold or donated.

A report 414 is generated, classifying the items. If the item is approved 416,418 and determined to be salvage content 420, the content will go to the salvage recovery module 100. If not salvageable, the content may go through a further classification 422 to determine whether the item is characterized as “clean” 424. If the item is characterized as “clean”, the contents are cleaned by the vendor and returned to the owner at a later date. If not “clean,” then the next step is either a disposal step 426, a recycle step 428 or a donate step 432.

If an item is classified for disposal, then the item is disposed of properly. If classified as recycling, recycling 428 would then take place at an appropriate location. Alternatively, an item may be donated 432 at an appropriate location, i.e., Goodwill store. In either case, recycle or donate, the vendor needs to provide documentation in the system 430. Based on that documentation, a report 434 on the value of the items donated and/or recycled is generated. Recycle 436 allows the adjuster to determine credits for disposal savings related to both recycling and donating as well as documented charitable donations for the file.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

We claim:

1. A method for determining, handling, tracking and recovering the salvage value of an item, the method comprising the steps of:
providing a server in communication with one or more access devices over a data communication network, the server programmed to:
receive data to itemize personal property of a property owner;
provide access to the data by an insurance adjuster of an insurance company;
providing a valuation module on the server in communication with the one or more access devices through the data communication network to receive the data relating to a property loss of one or more personal property items;
calculating the salvage value of the item using the valuation module, wherein the item is transformed from a disposable item into a salvageable item; and
crediting the insurance company a credit value based on the salvage value of the item

2. The method of claim 1, wherein the valuation module further includes a salvage module.

3. The method of claim 2, wherein the salvage module is configured to receive data relating to condition of an item and calculate a salvage value based on the data.

4. The method of claim 1 further includes the step of providing the salvage value on the server for access through at least one computing device by the insurance adjuster.

5. The method of claim 1 further includes the step of transferring a salvaged item to a third party salvage vendor for further handling.

6. The method of claim 5, wherein the step of handling the item includes transforming the item from a disposable item to a profitable item by selling the salvaged item through the third party salvage vendor.

7. The method of claim 1, wherein the valuation module further includes a pricing module.

8. The method of claim 7, wherein the pricing module is configured to receive data relating to type, category, description, condition, age and original purchase price of the item over the data communication network and using the data, calculate a value of owner-retained property.

9. The method of claim 8, wherein the pricing module provides a value price quote.

10. A salvage valuation system comprising:
a valuation module configured to communicate with one or more computing devices over a data communication network, wherein the module is accessible to insurance adjusters and salvage agents, the valuation module further comprising:
a pricing module configured to receive data over the data communication network and using the data to calculate a value of an item submitted as property loss; and,
a salvage module configured to receive data over the data communication network and using the data to calculate the value of an item submitted as a property loss to an insurance company,
wherein the item is transformed through the pricing module and the salvage module from a disposable item into a salvageable item.

11. The salvage valuation system of claim 9, wherein the pricing module further includes a first pricing tool for receiving data relating to a lower priced item and a second pricing tool for receiving data over the date communication network relating to a higher priced item.

12. A method for determining a value of recyclable building materials, the method comprising the steps of:
providing a server in communication with one or more access devices over a communication network, the server programmed to:
receive data to itemize building materials submitted as a loss;
provide access to the data by a salvage agent and an insurance agent of an insurance company;
providing a building materials module on the server in communication with the one or more access devices through the network to receive the data relating to a loss of building materials; and,
calculating a recycle value of the building materials using the building materials module;
transforming the building materials from a disposable item into a recyclable or reusable item; and
crediting the insurance company a credit value based on the recycle value of the building materials.

13. The method of claim 11, wherein method of calculating the recycle value of the building materials further includes maintaining an accessible database relating to current pricing information for a plurality of building materials.

14. The method of claim 11, wherein the method further includes calculating a disposal savings from the transformation of the building materials from a disposable item to a recyclable commodity.

15. A building materials valuation system comprising:
a building materials valuation module configured to communicate with one or more computing devices over a data communication network, wherein the module is accessible to insurance adjusters and salvage agents,
wherein the building materials module is configured to receive data over the data communication network and using the data to calculate a value of building materials submitted as property loss; and,
wherein the building materials are transformed through the building materials valuation module from a disposable item into a salvageable item.

16. The building materials valuation system of claim 15, wherein the system further includes a database relating to current pricing information for a plurality of building materials.

17. The building materials valuation system of claim 15, wherein the system further includes a disposal savings calculated from the transformation of the building materials from a disposable item to a recyclable commodity.

18. The building materials valuation system of claim 15, wherein the system further includes a building material credit value calculated from the transformation of the building materials from a disposable item to a recyclable commodity.

19. The building materials valuation system of claim 15, wherein the system further includes an environmentally-friendly solution by transforming building material from a disposal item to a recyclable item.

20. A method for determining, handling, tracking and recovering the value of contents subject to a total loss, the method comprising the steps of:
providing a server in communication with one or more access devices over a communication network, the server programmed to:
receive data to itemize property/homeowner contents loss;
provide access to the data by a salvage agent and an insurance adjuster of an insurance company;
providing contents recovery module on the server in communication with the one or more access devices through the data communication network to receive the data relating to the contents loss;
classifying the content as one or more of clean, salvage, recycle, dispose or donate;
calculating a monetary value of the contents based on its classification; and
crediting the insurance company a credit value based on the monetary value of the contents.
